(19) United States
(12) Patent Application Publication
(10) Pub. No.: US 2015/0341494 A1
(43) Pub. Date: Nov. 26, 2015

(54) Method, system, base station and cluster EPC for establishing group call context

(71) Applicant: ZTE CORPORATION, Shenzhen, Guangdong (CN)

(72) Inventor: Guoliang Zhou, Shenzhen (CN)

(21) Appl. No.: 14/758,479

(22) PCT Filed: Sep. 12, 2013
(86) PCT No.: PCT/CN2013/083419

§ 371 Date: Jun. 29, 2015

(30) Foreign Application Priority Data
Jan. 4, 2013 (CN) 201310001369.X

(51) Int. Cl. H04M 3/46; H04W 72/00; H04W 76/02; H04W 4/06; H04W 76/00

(52) U.S. Cl. CPC H04M 3/465; H04W 4/06; H04W 76/002; H04W 76/027; H04W 72/005

(57) ABSTRACT

Provided are a method and system for establishing a group call context. The method includes establishing a group call context between a cluster Evolved Packet Core (EPC) and a first base station to which speaking right UE belongs, establishing a group call context between the cluster EPC and a second base station to which non-speaking right UE belongs. A base station and a cluster EPC are also provided. Accordingly, the group call context can be established between the base station and a cluster network.

### TECHNICAL FIELD

The present disclosure relates to a Long Term Evolution (LTE) trunked communication system, and in particular to a method, system, base station and cluster Evolved Packet Core (EPC) for establishing a group call context.

### BACKGROUND

As a dedicated mobile communication dispatching system, digital trunked communication has technical features including channel sharing, dynamic allocation and the like, which can provide multiple departments, institutions and other group users with communication services, such as commanding and dispatching. With the development of broadband mobile communication, especially the speedy development of the fourth generation mobile communication LTE technology, multiple requirements, such as broadband, video and high speed, for the digital trunked communication system are also presented. Thus, the trunked communication based on the LTE technology is the development direction of the current digital cluster system.

The main task in the trunked communications is establishing a group call session. A session establishment using the LTE technology is based on the establishment of a group call context, so the main task of the trunked communication system based on the LTE technology is establishing a group call context. Since the trunked communication is implemented in a half-duplex communication way, and the same session can access multiple pieces of User Equipment (UE), users can be divided into speaking right users and non-speaking right users; the speaking right user transfers group call service data to a network through the UE, and then a network sends the group call service data to other non-speaking right users by broadcasting. The speaking right user needs to establish a Radio Resource Control (RRC) connection with an evolved Node B (eNB), therefore, a session connection of the speaking right user will be based on an LTE protocol, and the non-speaking right user does not need to establish an RRC connection with the eNB.

At present, in the trunked communication system based on the LTE technology, there is not yet a technical solution for supporting the establishment of the group call context between the base station and a cluster network (which is composed of the speaking right users and the non-speaking right users).

### SUMMARY

In view of this, the present disclosure is mainly intended to provide a method, system, base station and cluster EPC for establishing a group call context, so that the group call context can be established between the base station and the cluster network in a trunked communication system based on the LTE technology.

To this end, the technical solutions of the present disclosure are implemented as follows.

A method for establishing a group call context is provided, which may include that:

a group call context is established between a cluster EPC and a first base station to which speaking right UE belongs;

a group call context is established between the cluster EPC and a second base station to which non-speaking right UE belongs.

Preferably, before establishing the group call context, the method may further include that the speaking right UE establishes an RRC connection with the first base station and the cluster EPC respectively.

Preferably, before establishing the group call context between the cluster EPC and the first base station to which the speaking right UE belongs, the method may further include that the cluster EPC sends a generated group call context establishment request message to the first base station while the RRC connection is established.

Preferably, before establishing the group call context between the cluster EPC and the second base station to which the non-speaking right UE belongs, the method may further include that:

the cluster EPC sends a group call paging message to the second base station according to a generated group call context establishment request while the RRC connection is established;

after receiving the group call paging message, the second base station broadcasts the group call paging message in a coverage area of the second base station;

after receiving the group call paging message, the non-speaking right UE in the coverage area of the second base station returns a group call paging response message to the second base station;

after receiving the group call paging response message for the first time, the second base station returns the group call paging response message to the cluster EPC; and

after receiving the group call paging response message, the cluster EPC sends a group call context establishment request message to the second base station.

Preferably, establishing the group call context between the cluster EPC and the first base station to which the speaking right UE belongs, or establishing the group call context between the cluster EPC and the second base station to which the non-speaking right UE belongs may include that:

after receiving the group call context establishment request message, the first base station or the second base station establishes a cluster group call service channel resource, and establishes a corresponding group call radio access bearer; and

after completing the establishment of the cluster group call service channel resource, the first base station or the second base station broadcasts a group call configuration message through the cluster group call service channel resource, and returns a group call context establishment response message to the cluster EPC to complete the establishment of the group call context.

Preferably, the group call context establishment request message may carry contents of the group call context including a group call Identity (ID), a group call mode, a group call convergence maximum transmission bit rate, a group call radio access bearer list, a group call security capability and a group call security key;

the group call radio access bearer list may include a group call radio access bearer ID, a service quality parameter, a transport layer address, a General Data Transfer Platform (GTP) channel ID, a service bearer type and a Non-Access Stratum (NAS) data packet.

Preferably, the group call context establishment response message may include the group call ID and a list of successfully established group call radio access bearers and/or a list of unsuccessfully established group call radio access bearers;

the list of successfully established group call radio access bearers may include the group call radio access bearer ID, the transport layer address and the GTP channel ID; and

the list of unsuccessfully established group call radio access bearers may include the group call radio access bearer ID and a cause of failure.

A system for establishing a group call context is also provided, which includes base stations and a cluster EPC, wherein,

the base stations includes a first base station and a second base station, wherein the first base station is the one to which speaking right UE belongs, and the second base station is the one to which non-speaking right UE belongs; and

the cluster EPC is configured to establish a group call context with the first base station; and the cluster EPC is further configured to establish a group call context with the second base station.

Preferably, the system may further include UE, the UE may include the speaking right UE and the non-speaking right UE, wherein the speaking right UE is configured to establish the RRC connection with the first base station and the cluster EPC respectively.

Preferably, the cluster EPC may be further configured to send the generated group call context establishment request message to the first base station while the RRC connection is established.

Preferably, the cluster EPC may be further configured to send a group call paging message to the second base station according to a generated group call context establishment request while the RRC connection is established;

the second base station is further configured to broadcast the group call paging message in a coverage area of the second base station after receiving the group call paging message;

the non-speaking right UE is further configured to return a group call paging response message to the second base station after receiving the group call paging message;

the second base station is further configured to return the group call paging response message to the cluster EPC after receiving the group call paging response message for the first time; and

the cluster EPC is further configured to send a group call context establishment request message to the second base station after receiving the group call paging response message.

Preferably, the first base station or the second base station is further configured to, after receiving the group call context establishment request message, establish a cluster group call service channel resource, and establish a corresponding group call radio access bearer; the first base station or the second base station is further configured to, after completing the establishment of the cluster group call service channel resource, broadcast a group call configuration message through the cluster group call service channel resource, and return the group call context establishment response message to the cluster EPC to complete establishment of the group call context.

A cluster EPC is also provided, which includes a first group call module and a second group call module, wherein,

the first group call module is configured to establish a group call context with the first base station to which speaking right UE belongs; and

the second group call module is configured to establish a group call context with the second base station to which non-speaking right UE belongs.

Preferably, the cluster EPC may also include a first RRC module, which is configured to establish an RRC connection with the speaking right UE.

Preferably, the first group call module may be further configured to send the generated group call context establishment request message to the first base station while the RRC connection is established.

Preferably, the second group call module may be further configured to send the group call paging message to the second base station according to the generated group call context establishment request while the RRC connection is established, and send the generated group call context establishment request message to the second base station after receiving the group call paging response message returned by the second base station.

Preferably, the first group call module or the second group call module may be further configured to receive the group call context establishment response message returned by the first base station or the second base station.

A base station may be also provided, which may include a first base station to which speaking right UE belongs and a second base station to which non-speaking right UE belongs; wherein

the first base station includes a third group call module, which is configured to establish a group call context with the cluster EPC; and

the second base station includes a fourth group call module, which is configured to establish a group call context with the cluster EPC.

Preferably, the first base station may further include a second RRC module, which is configured to establish an RRC connection with the speaking right UE.

Preferably, the third group call module may be further configured to receive the group call context establishment request message sent by the cluster EPC while the RRC connection is established.

Preferably, the fourth group call module may be further configured to receive the group call paging message sent by the cluster EPC while the RRC connection is established, broadcast the group call paging message in a coverage area of the second base station after receiving the group call paging message, and send the group call paging response message to the cluster EPC after receiving the group call paging response message returned by the non-speaking right UE; and the fourth group call module is further configured to send the group call context establishment request message after the cluster EPC receives the group call paging response message.

Preferably, the third group call module or the fourth group call module may be further configured to, after receiving the group call context establishment request message sent by the cluster EPC, establish the cluster group call service channel resource, and establish the corresponding group call radio access bearer; the third group call module or the fourth group call module is further configured to, after completing the establishment of the cluster group call service channel resource, broadcast the group call configuration message through the cluster group call service channel resource, and return the group call context establishment response message to the cluster EPC.

The present disclosure discloses a method, system, base station and cluster EPC for establishing a group call context between the base station and the cluster network; a group call context is established between speaking right UE and a first base station through the cluster EPC, wherein the first base station is the one to which the speaking right UE belongs; a group call context is established between the non-speaking right UE and the second base station through the cluster EPC, wherein the second base station is the one to which the non-speaking right UE belongs; in this way, the group call context can be established between the base stations and the cluster network.

### BRIEF DESCRIPTION OF THE DRAWINGS

FIG. 1 is a flowchart of a method for establishing a group call context between a base station and a cluster network according to the present disclosure;

FIG. 2 is a structural diagram of a system for establishing a group call context between a base station and a cluster network according to the present disclosure;

FIG. 3 is a structural diagram of a cluster EPC provided by the present disclosure; and

FIG. 4 is a structural diagram of a base station provided by the present disclosure.

### DETAILED DESCRIPTION

The technical solutions of the present disclosure are further elaborated below in combination with the accompanying drawings and specific embodiments.

The main idea of establishing a group call context between a base station and a cluster network of the present disclosure is that: a group call context is established between the cluster EPC and a first base station to which speaking right UE belongs, and a group call context is established between the cluster EPC and a second base station to which non-speaking right UE belongs, thereby implementing the establishment of the group call context between the base stations and the cluster network.

Generally, there is only one speaking right UE, so there is only one first base station to which the speaking right UE belongs, and non-speaking right UE may be among the pieces of UE to which the first base station provides service; since multiple pieces of non-speaking right UE may belong to different base stations respectively, there may be multiple second base stations.

Before the group call context is established, the speaking right UE first needs to establish an RRC connection with the first base station and the cluster EPC respectively.

The cluster EPC sends a generated group call context establishment request message to the first base station while the RRC connection is established; meanwhile, the cluster EPC sends a group call paging message to the second base station according to the generated group call context establishment request; after receiving the group call paging message, the second base station broadcasts the group call paging message in its coverage area; after receiving the group call paging message, the non-speaking right UE in the coverage area of the second base station returns a group call paging response message to the second base station; after receiving the group call paging response message for the first time, the second base station returns the group call paging response message to the cluster EPC; after receiving the group call paging response message, the cluster EPC sends the group call context establishment request message to the corresponding second base station.

After receiving the group call context establishment request message, the first base station or the second base station establishes a cluster group call service channel resource, and establishes a corresponding group call radio access bearer; and after completing the establishment of the cluster group call service channel resource, the first base station or the second base station broadcasts a group call configuration message through the cluster group call service channel resource, and returns the group call context establishment response message to the cluster EPC to complete the group call context establishment.

The specific solutions of the present disclosure are illustrated below through the specific embodiments.

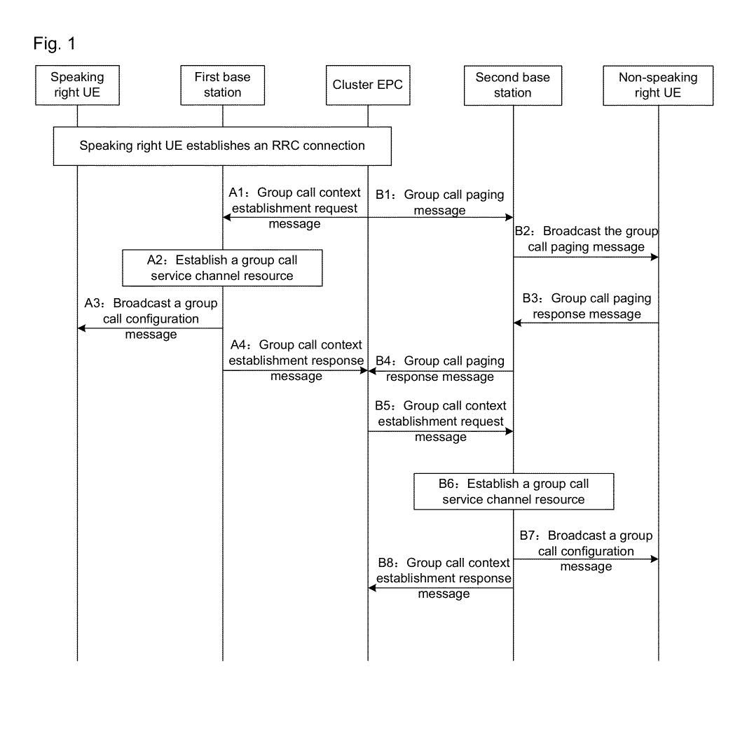

As shown in FIG. 1, the flow of establishing a group call context between the base stations and the cluster network of the present disclosure includes two parts: establishing a group call context between the cluster EPC and the first base station to which the speaking right UE belongs (including Step A1 to Step A4); establishing a group call context between the cluster EPC and the second base station to which the non-speaking right UE belongs (including Step B1 to Step B8). Before establishing the group call context, the speaking right UE needs to establish an RRC connection with the first base station and the cluster EPC respectively.

The flow of establishing a group call context between the cluster EPC and the first base station to which the speaking right UE belongs includes the following steps.

A1 includes that the speaking right UE establishes an RRC connection with the first base station and the cluster EPC, while the cluster EPC initiates the establishment of the group call context, and sends a group call context establishment request message to the first base station.

When the speaking right UE establishes the RRC connection with the first base station and the cluster EPC, the cluster EPC can learn the base station to which the speaking right UE belongs, namely the first base station.

The group call context establishment request message here is generated by the cluster EPC, and contents of the group call context includes a group call ID, a group call mode, a group call convergence maximum transmission bit rate, a group call radio access bearer list, a group call security capability, a group call security key and so on, wherein the group call ID is a serial number of a cluster call of this time, which is for uniquely identifying a certain cluster; the group call mode is the type of the cluster call of this time, which is one to one, or one to many.

The group call radio access bearer list here includes the following contents: a group call radio access bearer ID, a service quality parameter, a transport layer address, a GTP channel ID, a service bearer type, an NAS data packet and so on, wherein the group call radio access bearer ID is a serial number of a radio bearer, which is for uniquely identifying a certain radio bearer; the service bearer type is for identifying the type of a service of this time, such as data, voice, video, audio/video, and picture.

A2 includes that after receiving the group call context establishment request message, the first base station establishes a group call service channel resource, and needs to establish a corresponding group call radio access bearer according to the group call radio access bearer list. Since there are multiple types of group call services (indicated through the service bearer types), such as data, voice, video, audio/video, and picture, it is needed to establish corresponding bearers according to different service types, and the bearers corresponding to the different service types are indicated through the group call radio access bearer ID.

A3 includes that after completing the establishment of the cluster group call service channel resource, the first base station broadcasts a group call configuration message through a cluster group call service channel resource, and the speaking right UE and other non-speaking right UE of the first base station receive the group call configuration message and perform corresponding group call configuration.

A4 includes that the first base station returns a group call context establishment response message to the cluster EPC while broadcasting the group call configuration message, wherein the group call context establishment response message includes a group call ID and a list of successfully established group call radio access bearers and/or a list of unsuccessfully established group call radio access bearers. The group call ID is the same as the group call ID in the group call context establishment request message.

For the cluster group call service, the bearers corresponding to multiple service types may be established, as a result, the establishment of these bearers may be successful or failed; correspondingly, it is needed to carry the list of successfully established group call radio access bearers and/or the list of unsuccessfully established group call radio access bearers in the group call context establishment response message.

The list of successfully established group call radio access bearers includes a group call radio access bearer ID, a transport layer address and a GTP channel ID.

The list of unsuccessfully established group call radio access bearers includes a group call radio access bearer ID and a cause of failure.

The flow of establishing a group call context between the cluster EPC and the second base station to which the non-speaking right UE belongs includes the following steps.

B1 includes that the speaking right UE respectively establishes RRC connection with the first base station and the cluster EPC, while the cluster EPC sends a group call paging message to the second base station to which the non-speaking right UE belongs according to the group call ID in the group call context establishment request message. The cluster EPC can learn a corresponding cluster according to the group call ID; information of the cluster is recorded in a system where the cluster EPC is, and what is concerned in this step is information of the second base station.

B2 includes that after receiving the group call paging message, the second base station broadcasts the group call paging message in its coverage area.

B3 includes that after receiving the group call paging message, the non-speaking right UE in the coverage area of the second base station returns a group call paging response message to the second base station.

B4 includes that after receiving the group call paging response message for the first time, the second base station returns the group call paging response message to the cluster EPC.

B5 includes that the cluster EPC sends a group call context establishment request message to the second base station which returned the group call paging response message to the cluster EPC. The group call context establishment request message is the same as contents of the group call context included in the group call context establishment request message in step A1, and values of parameters in the contents of the group call context are the same.

B6 includes that after receiving the group call context establishment request message, the second base station establishes a group call service channel resource, and needs to establish a corresponding group call radio access bearer according to the group call radio access bearer list. Because there are multiple types of group call service (indicated through the service bearer type), such as data, voice, video, audio/video, and picture, it is needed to establish corresponding bearers according to different service types, and the bearers corresponding to the different service types are indicated through the group call radio access bearer ID.

B7 includes that after completing the establishment of the cluster group call service channel resource, the second base station broadcasts a group call configuration message through the cluster group call service channel resource, and the non-speaking right UE receives the group call configuration message and performs corresponding group call configuration.

B8 includes that the second base station returns a group call context establishment response message to the cluster EPC while broadcasting the group call configuration message, wherein the group call context establishment response message includes a group call ID and a list of successfully established group call radio access bearers and/or a list of unsuccessfully established group call radio access bearers.

For the cluster group call service, the bearers corresponding to multiple service types may be established, so establishment of these bearers may be successful or failed; correspondingly, it is needed to carry the list of successfully established group call radio access bearers and/or the list of unsuccessfully established group call radio access bearers in the group call context establishment response message.

The list of successfully established group call radio access bearers includes a group call radio access bearer ID, a transport layer address and a GTP channel ID.

The list of unsuccessfully established group call radio access bearers includes a group call radio access bearer ID and a cause of failure.

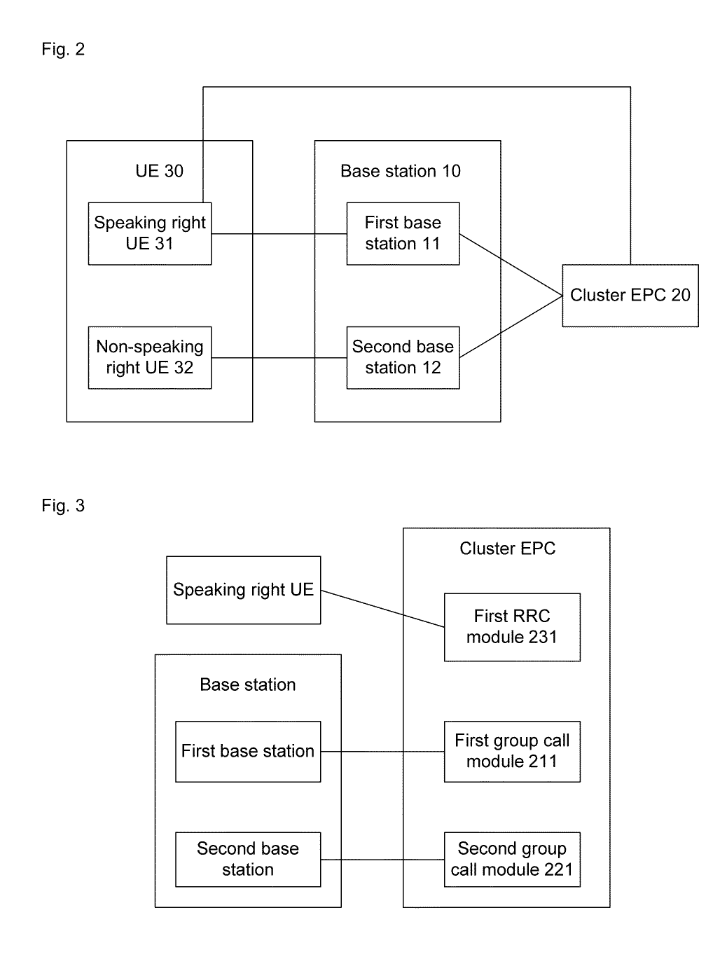

For implementing the above method, the present disclosure also provides a system for establishing a group call context between the base station and the cluster network; as shown in FIG. 2, the system includes the base station 10 and the cluster EPC 20, wherein,

the base station 10 includes the first base station 11 and the second base station 12; the first base station 11 is the one to which speaking right UE belongs, and the second base station 12 is the one to which non-speaking right UE belongs;

the cluster EPC 20 is configured to establish a group call context with the first base station 11; the cluster EPC 20 is further configured to establish a group call context with the second base station 12.

The system may further include the UE 30; the UE includes the speaking right UE 31 and the non-speaking right UE 32; wherein, the speaking right UE 31 is configured to establish an RRC connection with the first base station 11 and the cluster EPC 20 respectively.

The cluster EPC 20 is further configured to send a generated group call context establishment request message to the first base station 11 while the RRC connection is established.

The cluster EPC 20 is further configured to send a group call paging message to the second base station 12 according to the generated group call context establishment request while the RRC connection is established;

the second base station 12 is further configured to broadcast the group call paging message in its coverage area after receiving the group call paging message;

the non-speaking right UE 32 is further configured to return the group call paging response message to the second base station 12 after receiving the group call paging message;

the second base station 12 is further configured to return the group call paging response message to the cluster EPC 20 after receiving the first group call paging response message; and

the cluster EPC 20 is further configured to send the group call context establishment request message to the second base station 12 after receiving the group call paging response message.

The first base station 11 or the second base station 12 is further configured to, after receiving the group call context establishment request message, establish a cluster group call service channel resource, and establish a corresponding group call radio access bearer; the first base station or the second base station is further configured to, after completing the establishment of the cluster group call service channel resource, broadcast a group call configuration message through the cluster group call service channel resource, and return a group call context establishment response message to the cluster EPC 20 to complete the group call context establishment.

By the above way, the present disclosure implements the establishment of the group call context between the base station and the cluster network.

The present disclosure also provides a cluster EPC, which is configured to establish a group call context with the base station; as shown in FIG. 3, the cluster EPC includes a first group call module 211 and a second group call module 221, wherein,

the first group call module 211 is configured to establish a group call context with the first base station to which speaking right UE belongs; and

the second group call module 221 is configured to establish a group call context with the second base station to which non-speaking right UE belongs.

The cluster EPC may further include a first RRC module 231, which is configured to establish an RRC connection with the speaking right UE.

The first group call module 211 is further configured to send a generated group call context establishment request message to the first base station while the RRC connection is established.

The second group call module 221 is further configured to send a group call paging message to the second base station according to the generated group call context establishment request while the RRC connection is established, and send the generated group call context establishment request message to the second base station after receiving the group call paging response message returned by the second base station.

The first group call module 211 or the second group call module 221 is further configured to receive a group call context establishment response message returned by the first base station or the second base station.

In addition, all of the first group call module 211, the second group call module 221 and the first RRC module 231 may be implemented by a Central Processing Unit (CPU), a Micro Processing Unit (MPU), a Digital Signal Processor (DSP) or a Field-Programmable Gate Array (FPGA) in the cluster EPC and hardware with a communication function.

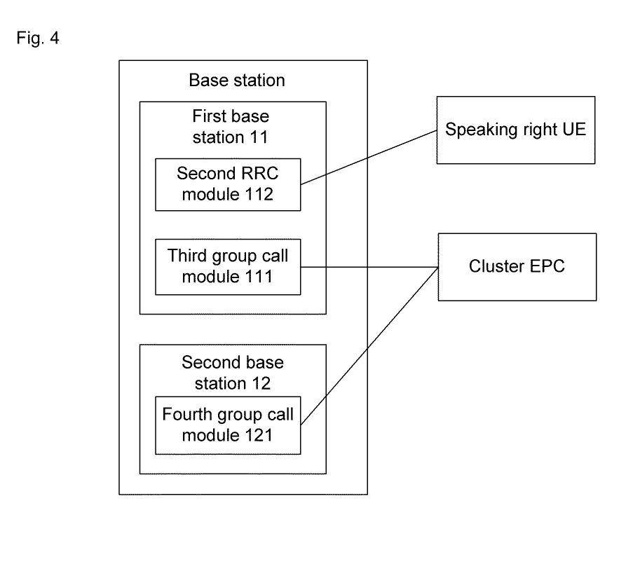

The present disclosure also provides a base station; as shown in FIG. 4, the base station includes a first base station 11 to which speaking right UE belongs and a second base station 12 to which non-speaking right UE belongs;

the first base station 11 includes a third group call module 111, which is configured to establish a group call context with the cluster EPC;

the second base station 12 includes a fourth group call module 121, which is configured to establish a group call context with the cluster EPC.

The first base station 11 further includes a second RRC module 112, which is configured to establish an RRC connection with the speaking right UE.

The third group call module 111 is further configured to receive the group call context establishment request message sent by the cluster EPC while the RRC connection is established.

The fourth group call module 121 is further configured to receive the group call paging message sent by the cluster EPC while the RRC connection is established, broadcast the group call paging message in the coverage area of the second base station 12 after receiving the group call paging message, and send the group call paging response message to the cluster EPC after receiving the group call paging response message returned by the non-speaking right UE; the fourth group call module 121 is further configured to send the group call context establishment request message after the cluster EPC receives the group call paging response message.

The third group call module 111 or the fourth group call module 121 is further configured to, after receiving the group call context establishment request message sent by the cluster EPC, establish the cluster group call service channel resource, and establish the corresponding group call radio access bearer; the third group call module 111 or the fourth group call module 121 is further configured to, after completing the establishment of the cluster group call service channel resource, broadcast the group call configuration message through the cluster group call service channel resource, and return the group call context establishment response message to the cluster EPC.

In addition, both the third group call module 111 and the second RRC module 112 may be implemented by CPU, MPU, DSP or FPGA in the first base station 11 and hardware with a communication function.

The fourth group call module 121 may be implemented by CPU, MPU, DSP or FPGA in the second base station 12 and hardware with a communication function.

The above are only the preferred embodiments of the present disclosure and not intended to limit the scope of the claims of the present disclosure.

What is claimed is:

1. A method for establishing a group call context, comprising:
establishing a group call context between a cluster Evolved Packet Core (EPC) and a first base station to which speaking right User Equipment (UE) belongs;
establishing a group call context between the cluster EPC and a second base station to which non-speaking right UE belongs.

2. The method for establishing a group call context according to claim 1, before establishing the group call context, the method further comprising: establishing, by the speaking right UE, a Radio Resource Control (RRC) connection with the first base station and the cluster EPC respectively.

3. The method for establishing a group call context according to claim 2, before establishing the group call context between the cluster EPC and the first base station to which the speaking right UE belongs, the method further comprising: sending, by the cluster EPC, a generated group call context establishment request message to the first base station while the RRC connection is established:
or,
before establishing the group call context between the cluster EPC and the second base station to which the non-speaking right UE belongs, the method further comprising:
sending, by the cluster EPC, a group call paging message to the second base station according to a generated group call context establishment request while the RRC connection is established;
after the second base station receives the group call paging message, broadcasting, by the second base station, the group call paging message in a coverage area of the second base station;
after the non-speaking right UE in the coverage area of the second base station receives the group call paging message, returning, by the non-speaking right UE in the coverage area of the second base station, a group call paging response message to the second base station;
after the second base station receives the group call paging response message for the first time, returning, by the second base station, the group call paging response message to the cluster EPC; and
after the cluster EPC receives the group call paging response message, sending, by the cluster EPC, a group call context establishment request message to the second base station.

4. (canceled)

5. The method for establishing a group call context according to claim 3, wherein establishing the group call context between the cluster EPC and the first base station to which the speaking right UE belongs, or establishing the group call context between the cluster EPC and the second base station to which the non-speaking right UE belongs comprises:
after the first base station or the second base station receives the group call context establishment request message, establishing, by the first base station or the second base station, a cluster group call service channel resource, and establishing a corresponding group call radio access bearer; and
after the first base station or the second base station completes the establishment of the cluster group call service channel resource, broadcasting, by the first base station or the second base station, a group call configuration message through the cluster group call service channel resource, and returning a group call context establishment response message to the cluster EPC to complete the establishment of the group call context.

6. The method for establishing a group call context according to claim 5, wherein
the group call context establishment request message carries contents of the group call context comprising a group call Identity (ID), a group call mode, a group call convergence maximum transmission bit rate, a group call radio access bearer list, a group call security capability and a group call security key;
the group call radio access bearer list comprises a group call radio access bearer ID, a service quality parameter, a transport layer address, a General Data Transfer Platform (GTP) channel ID, a service bearer type and a Non-Access Stratum (NAS) data packet.

7. The method for establishing a group call context according to claim 6, wherein the group call context establishment response message comprises the group call ID and a list of successfully established group call radio access bearers and/or a list of unsuccessfully established group call radio access bearers;
the list of successfully established group call radio access bearers comprises the group call radio access bearer ID, the transport layer address and the GTP channel ID; and
the list of unsuccessfully established group call radio access bearers comprises the group call radio access bearer ID and a cause of failure.

8. A system for establishing a group call context, comprising base stations and a cluster Evolved Packet Core (EPC), wherein,
the base stations comprise a first base station and a second base station, wherein the first base station is a base station to which speaking right User Equipment (UE) belongs, and the second base station is a base station to which non-speaking right UE belongs; and
the cluster EPC is configured to establish a group call context with the first base station; and the cluster EPC is further configured to establish a group call context with the second base station.

9. The system for establishing a group call context according to claim 8, further comprising UE; the UE comprises the speaking right UE and the non-speaking right UE, wherein the speaking right UE is configured to establish a Radio Resource Control (RRC) connection with the first base station and the cluster EPC respectively.

10. The system for establishing a group call context according to claim 9, wherein the cluster EPC is further configured to send a generated group call context establishment request message to the first base station while the RRC connection is established.

11. The system for establishing a group call context according to claim 9, wherein the cluster EPC is further configured to send a group call paging message to the second base station according to a generated group call context establishment request while the RRC connection is established;
the second base station is further configured to broadcast the group call paging message in a coverage area of the second base station after receiving the group call paging message;
the non-speaking right UE is further configured to return a group call paging response message to the second base station after receiving the group call paging message;
the second base station is further configured to return the group call paging response message to the cluster EPC after receiving the group call paging response message for the first time; and
the cluster EPC is further configured to send a group call context establishment request message to the second base station after receiving the group call paging response message.

12. The system for establishing a group call context according to claim 10, wherein the first base station or the second base station is further configured to, after receiving the group call context establishment request message, establish a cluster group call service channel resource, and establish a corresponding group call radio access bearer; the first base station or the second base station is further configured to, after completing the establishment of the cluster group call service channel resource, broadcast a group call configuration message through the cluster group call service channel resource, and return a group call context establishment response message to the cluster EPC to complete establishment of the group call context.

13. A cluster Evolved Packet Core (EPC), comprising a first group call module and a second group call module, wherein
the first group call module is configured to establish a group call context with a first base station to which speaking right User Equipment (UE) belongs; and
the second group call module is configured to establish a group call context with a second base station to which non-speaking right UE belongs.

14. The cluster EPC according to claim 13, further comprising a first Radio Resource Control (RRC) module, which is configured to establish an RRC connection with the speaking right UE.

15. The cluster EPC according to claim 14, wherein the first group call module is further configured to send a generated group call context establishment request message to the first base station while the RRC connection is established.

16. The cluster EPC according to claim 14, wherein the second group call module is further configured to send a group call paging message to the second base station according to a generated group call context establishment request while the RRC connection is established, and send the generated group call context establishment request message to the second base station after receiving a group call paging response message returned by the second base station.

17. The cluster EPC according to claim 15, wherein the first group call module or the second group call module is further configured to receive a group call context establishment response message returned by the first base station or the second base station.

18. A base station, comprising a first base station to which speaking right User Equipment (UE) belongs and a second base station to which non-speaking right UE belongs, wherein
the first base station comprises a third group call module, which is configured to establish a group call context with a cluster Evolved Packet Core (EPC); and
the second base station comprises a fourth group call module, which is configured to establish a group call context with the cluster EPC.

19. The base station according to claim 18, wherein the first base station further comprises a second Radio Resource Control (RRC) module, which is configured to establish an RRC connection with the speaking right UE.

20. The base station according to claim 19, wherein
the third group call module is further configured to receive a group call context establishment request message sent by the cluster EPC while the RRC connection is established; or
the fourth group call module is further configured to receive a group call paging message sent by the cluster EPC while the RRC connection is established, broadcast the group call paging message in a coverage area of the second base station after receiving the group call paging message, and send a group call paging response message to the cluster EPC after receiving the group call paging response message returned by the non-speaking right UE; and the fourth group call module is further configured to send a group call context establishment request message after the cluster EPC receives the group call paging response message.

21. (canceled)

22. The base station according to claim 20, wherein the third group call module or the fourth group call module is further configured to, after receiving the group call context establishment request message sent by the cluster EPC, establish a cluster group call service channel resource, and establish a corresponding group call radio access bearer; the third group call module or the fourth group call module is further configured to, after completing the establishment of the cluster group call service channel resource, broadcast a group call configuration message through the cluster group call service channel resource, and return a group call context establishment response message to the cluster EPC.
